(19) United States
(12) Patent Application Publication
(10) Pub. No.: US 2014/0002590 A1
(43) Pub. Date: Jan. 2, 2014

(54) Method for Producing a Panoramic Image and Implementation Apparatus

(71) Applicants: Stéphane Auberger, Noisy-le-Grand (FR); Nicolas Hanus, Vimines (FR)

(72) Inventors: Stéphane Auberger, Noisy-le-Grand (FR); Nicolas Hanus, Vimines (FR)

(73) Assignee: ST-ERICSSON SA, Plan-les-Ouates (CH)

(21) Appl. No.: 13/995,911

(22) PCT Filed: Dec. 20, 2011
(86) PCT No.: PCT/EP2011/073322

§ 371 Date: Sep. 18, 2013

(30) Foreign Application Priority Data
Dec. 20, 2010 (FR) 1060836

(51) Int. Cl. H04N 5/232

(52) U.S. Cl. CPC H04N 5/23238
USPC 348/36

(57) ABSTRACT

A method and apparatus for aligning two successive images of a video sequence to produce a panoramic image is disclosed. To align the images, the apparatus corrects a first displacement vector of a target image in the video sequence. The first vector is determined by estimating the displacement of a target image with respect to at least one previous image of the video sequence.

The invention relates to the production of a panoramic image on the basis of successive images extracted from a video sequence, and more particularly to the alignment of these images.

A panoramic image is an image possessing an exceptionally wide field. These panoramic images may be created with a panoramic camera comprising objectives with exceptionally wide field, or else on the basis of capturing a succession of images with a picture-taking apparatus by swivelling the latter in relation to a horizontal axis. They can thus be produced on the basis of a digital camera and of software making it possible to assemble several pictures, or else on the basis of a video sequence recorded with a video camera, or else a digital camera in video mode, and on the basis of which use is made of the images of the video sequence which are assembled.

In the case of a digital camera in a photographic capture mode, several successive pictures are taken with a camera fixed on an axis and which turns between each picture, causing two consecutive pictures to overlap. Software thereafter makes it possible to assemble the various images obtained. The field of view is widened artificially in this way.

In the case of producing a panoramic image on the basis of a video sequence, a video sequence is firstly recorded by panning, that is to say by performing a swivel motion about a fixed axis. The images of the video sequence are, for example, recorded at a frequency of 25 images per second. The images thus captured during the video sequence will serve to construct a panoramic photographic image.

To construct a panoramic image on the basis of a video sequence, it is firstly necessary to estimate the displacement existing between two successive images. This estimation of displacement makes it possible to determine a displacement vector of an image with respect to a previous image. This displacement vector then makes it possible to correctly align the two successive images within the panoramic image. Estimation of displacement is well known and is based on a method of agreement between the blocks which work on the basis of the luminance of the various input images.

However, if a disturbance appears between two consecutive images, such as for example an abrupt change of brightness due to a modification of the capture parameters or the appearance of a disturbing motion in the scene, the displacement estimation agreement method may be flawed. In this case, an erroneous displacement vector will be returned by displacement estimation means and the final displacement vector will be erroneous. There will, consequently, be a disagreement or indeed even a space within final panoramic images.

The invention is aimed at alleviating these drawbacks by correcting a displacement vector that may be erroneous during the alignment of two successive images of a video sequence for the production of a panoramic image.

According to one aspect, there is proposed in one mode of production, a method for aligning two successive images of a video sequence for the production of a panoramic image.

This method comprises a correction of a first displacement vector of a target image of the video sequence, the said first vector being determined by an estimation of the displacement of the target image with respect to at least one previous image of the video sequence.

Preferably, the correction comprises:
a determination of the average of the horizontal coordinates of the displacement vectors of at least one image preceding the target image;
a detection of the first vector as suspect vector in the case where a difference is detected between the horizontal coordinate of the first vector and the said average;
a comparison of the horizontal coordinate of a second displacement vector of an image following the said target image with the said average;
a correction of the suspect vector in the case where the horizontal coordinate of the second displacement vector is greater than the said average.

The correction advantageously comprises a determination of the variance of the average.

Preferably, a difference is detected between the horizontal coordinate of the first displacement vector and the said average if the subtraction between the horizontal coordinate of the first displacement vector and the said average is greater than the said variance.

The coordinate of the displacement vector is preferably similar to the said average if their difference is less than the said variance.

Advantageously, the correction of the suspect vector comprises a replacement of the first vector with the displacement vector of the image preceding the target image.

According to another aspect, there is proposed in one mode of production, an apparatus furnished with digital picture-taking means, comprising means for aligning two successive images of a video sequence for the production of a panoramic image.

The alignment means comprise means for correcting a first displacement vector of a target image of a video sequence, the said first vector being determined by means for estimating the displacement between two images of the video sequence that are able to estimate the displacement vector of an image with respect to at least one previous image.

Preferably, the alignment means comprise:
means for determining an average that are able to determine the average of the horizontal coordinates of the displacement vector of at least one image preceding the target image;
detection means able to detect the first vector as suspect vector in the case where a difference is detected between the horizontal coordinate of the first vector and the said average;
comparison means able to compare the horizontal coordinate of a second displacement vector of an image following the said target image with the said average; and
correction means able to correct the suspect vector in the case where the horizontal coordinate of the second displacement vector is similar to the said average.

The alignment means preferably comprise variance determination means able to determine the variance of the said average.

The detection means can advantageously comprise calculation means able to calculate a subtraction between the horizontal coordinate of the first displacement vector and the said average, and a first comparison module able to compare the said subtraction with the said variance.

The comparison means can also advantageously comprise a second comparison module able to compare the difference between the coordinate of the second displacement vector and the said average with the said variance.

Preferably, the correction means can comprise replacement means able to replace the first vector with the displacement vector of the image preceding the target image.

Other advantages and characteristics of the invention will become apparent on examining the wholly non-limiting detailed description of the modes of production and of implementation, and the appended drawings in which:

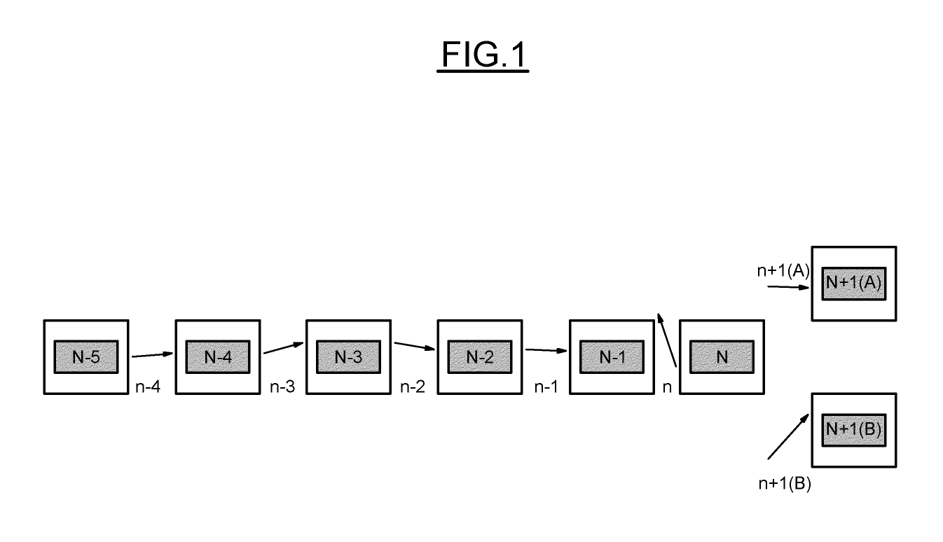

FIG. 1 represents in a schematic manner the checking of the displacement vectors of two successive images of a video sequence;

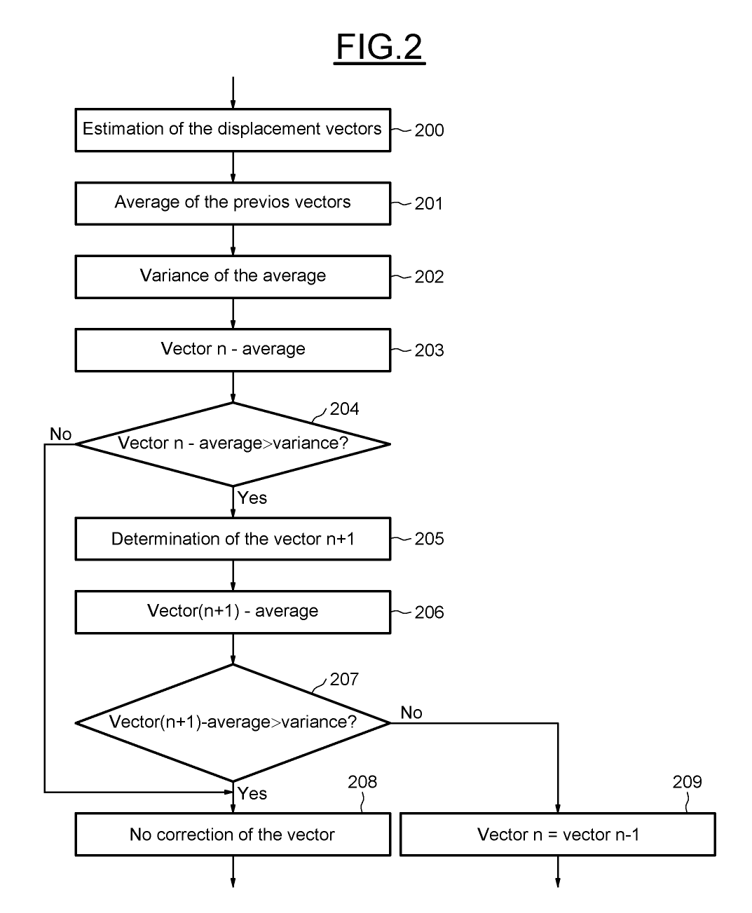

FIG. 2 represents a flowchart of a method for aligning two successive images of a video sequence for the production of a panoramic image according to one mode of implementation; and

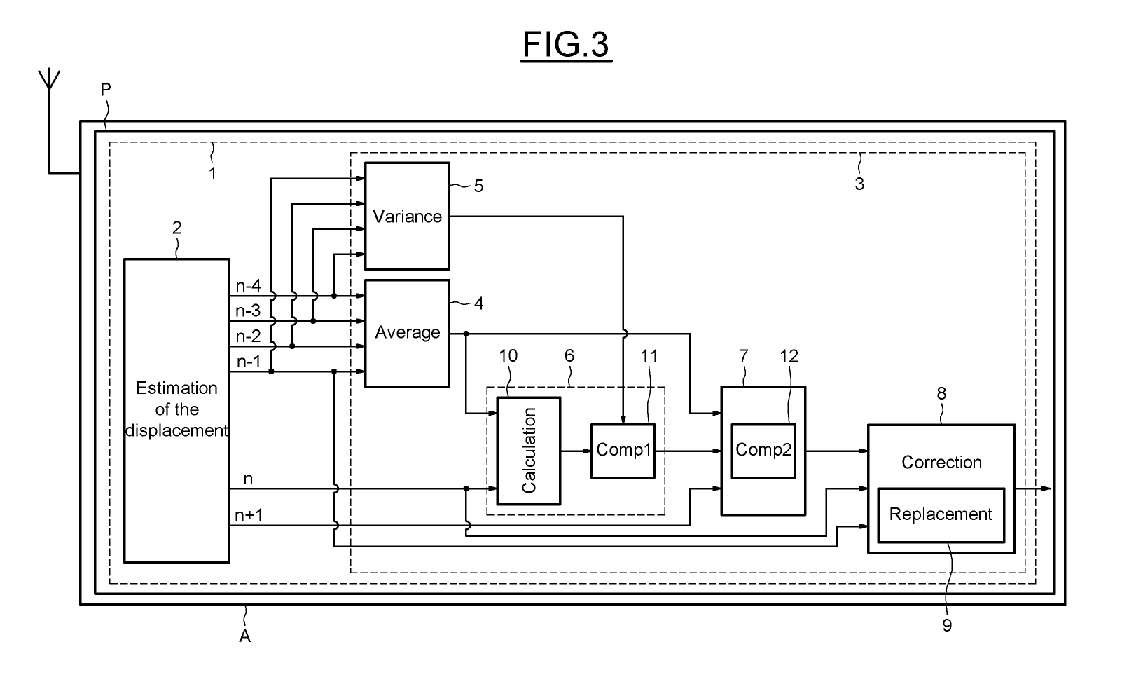

FIG. 3 schematically represents an apparatus comprising digital photography means comprising means for aligning two successive images of a video sequence for the production of a panoramic image, according to one mode of production.

In FIG. 1 is represented in a schematic manner an example of checking of the displacement vectors determined for each of successive images constituting a final panoramic image.

Firstly, successive images N−5, N−4, N−3, N−2, N−1, N, N+1(A) and N+1(B) are represented. These successive images are extracted from a video sequence to produce a panoramic image. The displacement vectors n−4, n−3, n−2, n−1, n, n+1(A) and n+1 (B) determined for each image are represented lower down.

The displacement vectors are determined by comparing an image with the previous image in the video sequence. Thus, the displacement vector n−4 of the image N−4 is determined by comparing the previous image N−5 with the image N−4.

For a target image N, we determine whether a first displacement vector n is a suspect vector, that is to say a displacement vector differing from the previous displacement vectors. In the example presented in FIG. 1, the vectors n−4 to n−1 are directed from left to right with a small inclination differing little between the vectors, while the vector n is directed from right to left with a large inclination. The vector n is thus considered in this example as differing from the previous vectors.

It is determined that a vector n is suspect by calculating firstly an average of the displacement vectors of the previous images, and more particularly by calculating the average of the horizontal coordinates of the previous displacement vectors.

The horizontal coordinate of the said first vector n is then compared with the thus calculated average of the horizontal coordinates of the previous vectors. If the horizontal coordinate of the first vector n is different from the calculated average, the said first vector n is then classed as suspect vector. The suspect vector is not corrected directly since this difference of horizontal coordinate may be due to numerous reasons.

The horizontal coordinate of the displacement vector n+1 of the following image N+1 is then checked so as to know whether or not the first vector n, then classed suspect, of the target image N needs to be corrected.

Accordingly, the displacement vector n+1 of the following image N+1 is determined, and it is compared with the previously calculated average.

If the displacement vector n+1 of the following image N+1 corresponds to the calculated average of the displacement vectors of the images preceding the target image N as in the case of the vector n+1(A) determined for the following image N+1(A), the first displacement vector classed as suspect is indeed erroneous and needs to be corrected.

In the converse case, that is to say if the horizontal coordinate of the displacement vector n+1 of the following image N+1 remains different from the said average calculated as in the case of the vector n+1(B) determined for the following image N+1(B), the suspicion of error of estimation of the first vector n is not confirmed. Henceforth, the displacement vector n, classed as suspect, of the target image N is not corrected.

In FIG. 2 is schematically represented a flowchart of a mode of implementation of a method for aligning two successive images of a video sequence for the production of a panoramic image, comprising a correction of a first displacement vector of a target image of the video sequence.

The displacement vectors are determined initially, in an initial step 200, with the aid of a method for estimating the displacement between two successive images of a video sequence. Each vector is determined for an image on the basis of at least one previous image.

In a first step 201 of the method, an average of the horizontal coordinates of the displacement vectors of at least one image preceding the target is determined. In a following step 202, the variance of the said average calculated in the previous step is determined.

The difference between the horizontal coordinate of the first vector of the target image n, denoted vector n, and the said average calculated in the first step 201, is thereafter calculated in a step 203.

The result of the difference between the horizontal coordinate of the first vector of the target image n and the said average is compared, in a following step 204, with the variance calculated in step 202. If the difference calculated in step 203 is less than the variance calculated in step 201, we pass directly to step 208 in which the said first vector is not corrected. On the other hand, if the difference calculated in step 203 is greater than the variance calculated in step 202, then the displacement vector of the following image, denoted vector n+1, is determined in a following step 205. In a following step 206, the horizontal coordinate of the vector n+1 of the following image is subtracted from the average calculated in step 201. In a following step 207, the result of the subtraction thus calculated in the previous step 206 is compared with the variance calculated in step 202.

If the result of the subtraction is greater than the variance, this signifies that the vector of the following image n+1 is also different from the average calculated for the previous vectors, and in this case it is not possible to be certain that the first vector of the target image n considered to be suspect is really erroneous. Indeed, this can correspond to a displacement of the camera or to an instability of the sequence. In this case we pass to the following step 208 in which the vector of the target image n is not corrected.

On the other hand, if the result of the subtraction between the horizontal coordinate of the displacement vector of the following image n+1 and the average is less than the variance, then the said first vector of the target image n is replaced, in a step 209, with the displacement vector of the image n−1 preceding the target image. The disturbance encountered for the determination of the displacement vector of the target image is thus corrected so as to obtain an undisturbed panoramic image.

In FIG. 3 is represented in a schematic manner an apparatus A, such as a mobile telephone apparatus, comprising means P for capturing digital photographic images able to record a video sequence comprising means 1 of alignment of two successive images of a video sequence for the production of a panoramic image.

The alignment means 1 comprise means 2 for estimating the displacement between two successive images of the video sequence, which are able to estimate the displacement vector of an image with respect to at least one previous image, and means 3 for correcting a first displacement vector n of a target image N of a video sequence.

The correction means 3 comprise means 4 for determining an average, which are able to determine the average of the horizontal coordinates of the displacement vectors of at least one image preceding the target image N (the displacement vectors of the previous images are denoted n−1, n−2, n−3, n−4, etc.). The correction means 3 also comprise variance determination means 5, able to determine the variance of the said average. The correction means 3 also comprise detection means 6 able to detect the first vector of the target image N as a suspect vector in the case where a difference is detected between the horizontal coordinate of the said first vector and the said average, and comparison means 7 able to compare the horizontal coordinate of a second displacement vector n+1 of an image N+1 following the said target image N with the said average. Finally, the correction means 3 comprise correction means 8 able to correct the suspect vector in the case where the horizontal coordinate of the second displacement vector is similar to the said average.

The estimation means 2 deliver as output the displacement vectors of the images preceding the target image, that is to say of the vectors n−1, n−2, n−3 and n−4, for example, to means 4 for determining the average, as well as to the means 5 for determining the variance. The means 4 for determining the average calculate the average of the horizontal coordinates of the displacement vectors for the various images preceding the target image n provided.

The means 5 for determining the variance also calculate the variance of the said average on the basis of the same data. The average calculated by the means 4 for determining the average is delivered to calculation means 10 included in the detection means 6. These calculation means 10 also receive as input the coordinates of the first vector n of the target image N that are delivered by the means for estimating the displacement 2. The calculation means 10 calculate a subtraction between the horizontal coordinate of the first displacement vector n of the target image N, and the said average calculated by the means 4 for determining the average. The result of this subtraction is delivered by the calculation means 10 to a first comparison module 11 also included in the detection means 6. The first comparison module 11 also receives as input the variance calculated by the means 5 for determining the variance.

The first comparison module 11 compares the result of the said subtraction determined by the calculation means 10 with the said variance. If the result of the subtraction is less than the said variance, the first vector n of the target image N is similar to the previous vectors, and does not have to be corrected. In this case, a signal is delivered as output from the first comparison module 11 to the comparison means 7 which deliver as output a signal indicating that the correction means 8 need not perform any correction of the first displacement vector n of the target image N. The correction means 8, receiving as input also the first displacement vector n of the target image N, deliver, in this case as output, the first displacement vector n uncorrected.

On the other hand, if the result of the subtraction calculated by the calculation means 10 is greater than the said variance, the first comparison module 11 delivers as output a signal indicating that the first displacement vector n of the target image N is suspect. This signal is delivered to the comparison means 7 which also receive as input the average calculated by the means 4 for determining the average, together with the coordinates of a displacement vector n+1, determined by the estimation means 2, of the image N+1 following the target image N.

The comparison means 7 comprise a second comparison module 12 able to compare the difference between the coordinate of the second displacement vector n+1 and the said average, with the said variance. If the difference between the horizontal coordinate of the second vector n+1 and the average is less than the variance, the determination means 7 deliver as output a signal confirming that the first displacement vector n of the target image N is erroneous. The correction means 8 receive this signal as input, thus signifying that the first displacement vector n of the target image N needs to be corrected.

The correction means 8 comprise replacement means 9 able to replace the first displacement vector n of the target image N with the displacement vector n−1 of the image preceding the target image, i.e. the image N−1. Accordingly, the correction means 8 also receive as input the coordinates, determined by the estimation means 2, of the previous vector n−1. The correction means 8 deliver as output at this moment the new, corrected, coordinates of the first vector n corresponding to the coordinates of the displacement vector n−1 of the image N−1 preceding the target image N.

On the other hand, if the difference between the horizontal coordinate of the second displacement vector n+1 and the said average is greater than the said variance, a signal is delivered as output from the comparison means 7 to the correction means 8, indicating that the first displacement vector of the target image n need not be corrected. The correction means 8 then deliver as output the coordinates, uncorrected, of the first displacement vector of the target image n.

It is therefore proposed, according to the present description, to correct a displacement vector that may be erroneous during the alignment of two successive images of a video sequence for the production of a panoramic image, by replacing the displacement vector of the target image with the displacement vector of the image preceding the target image if the displacement vector of the image following the target image possesses a displacement vector comparable with the average of the displacement vectors of at least one image preceding the target image in contradistinction to the displacement vector of the target image which is different.

In this way it is possible to alleviate displacement vector estimation errors due, for example, to abrupt changes of brightness.

1-12. (canceled)

13. A method for aligning successive images of a video sequence to produce a panoramic image, the method comprising:
estimating a displacement of a target image of a video sequence with respect to at least one previous image of the video sequence; and
correcting the first displacement vector of the target image of the video sequence, wherein the first displacement vector is determined based on the estimated displacement of the target image with respect to the at least one previous image.

14. The method of claim 13 wherein correcting the first displacement vector of the target image comprises:
determining an average of horizontal coordinates of displacement vectors of at least one image preceding the target image;
detecting the first displacement vector as a suspect vector if a difference between a horizontal coordinate of the first displacement vector and the average is detected;
comparing a horizontal coordinate of a second displacement vector associated with an image that follows the target image in the video sequence with the average; and
correcting the suspect vector if the horizontal coordinate of the second displacement vector is similar to the average.

15. The method of claim 14 wherein correcting the suspect vector determining a variance of the average.

16. The method of claim 15 further comprising detecting a difference between the horizontal coordinate of the first displacement vector and the average if a calculated difference between the horizontal coordinate of the first displacement vector and the average is greater than the variance.

17. The method of claim 15 wherein the horizontal coordinate of the second displacement vector is similar to the average if a calculated difference between the horizontal coordinate of the second displacement vector and the average is less than the variance.

18. The method of claim 14 wherein correcting the suspect vector comprises replacing the first displacement vector with the displacement vector of the image preceding the target image.

19. A camera-equipped device comprising:
a processing circuit configured to execute the functions of:
an alignment module configured to align successive images of a video sequence to produce a panoramic image, the alignment module comprising:
an estimating function configured to:
estimate a displacement between a target image of the video sequence and the at least one previous image; and
estimate a displacement vector of the target image with respect to the at least one previous image based on the estimated displacement; and
a correcting function to correct the first displacement vector of the target image of a video sequence,

20. The camera-equipped device of claim 19 wherein the correction function comprises:
a determination function configured to determine an average of horizontal coordinates of displacement vectors of at least one image preceding the target image;
a detection function configured to detect the first displacement vector as a suspect vector if a difference between a horizontal coordinate of the first displacement vector and the average is detected;
a comparison function configured to compare a horizontal coordinate of a second displacement vector of an image following the target image with the average; and
a correction module configured to correct the suspect vector if the horizontal coordinate of the second displacement vector is similar to the said average.

21. The camera-equipped device of claim 19 wherein the correction function comprises a variance determination function configured to determine a variance of the average.

22. The camera-equipped device of claim 21 wherein the detection function comprises:
a calculation function configured to calculate a subtraction between the horizontal coordinate of the first displacement vector and the average; and
a first comparison module configured to compare a result of the subtraction with the variance.

23. The camera-equipped device of claim 21 wherein the comparison function comprises a second comparison module configured to compare a difference between the horizontal coordinate of the second displacement vector and the average with the variance.

24. The camera-equipped device of claim 19 wherein the correction means comprises a replacement function configured to replace the first displacement vector with a displacement vector of the image preceding the target image.
